(19) United States
(12) Patent Application Publication
(10) Pub. No.: US 2025/0232182 A1
(43) Pub. Date: Jul. 17, 2025

(54) N-STEP RETURN-BASED IMPLICIT REGULARIZATION OFFLINE REINFORCEMENT LEARNING METHOD AND APPARATUS

(71) Applicant: FOUNDATION OF SOONGSIL UNIVERSITY-INDUSTRY COOPERATION, Seoul (KR)

(72) Inventors: Min Hae KWON, Seoul (KR); Dong Su LEE, Seoul (KR)

(73) Assignee: FOUNDATION OF SOONGSIL UNIVERSITY-INDUSTRY COOPERATION, Seoul (KR)

(21) Appl. No.: 18/748,768

(22) Filed: Jun. 20, 2024

(30) Foreign Application Priority Data
Jan. 17, 2024 (KR) 10-2024-0007541

(51) Int. Cl. G06N 3/092

(52) U.S. Cl. CPC G06N 3/092

(57) ABSTRACT

An offline reinforcement learning apparatus for n-step return-based implicit regularization is disclosed. The offline reinforcement learning apparatus comprises a processor; and a memory connected to the processor, wherein the memory comprises program instructions, in response to being executed by the processor, perform operations comprising, sampling, among datasets collected in a preset domain, some datasets including state, action, state at the next time point, reward, and return in n-step, calculating an objective function of a state value model that evaluates a value of a specific state using the sampled data set to update a parameter of the state value model, setting a TD (temporal difference) target based on the state value model, calculating an objective function of a state-action value model that evaluates a value of a specific state and action.

### CROSS-REFERENCE TO RELATED APPLICATIONS

This application claims the benefit of Korean Application No. 10-2024-0007541, filed Jan. 17, 2024, in the Korean Intellectual Property Office. All disclosures of the document named above are incorporated herein by reference.

### TECHNICAL FIELD

The present invention relates to an n-step return-based implicit regularization offline reinforcement learning method and apparatus.

### BACKGROUND ART

For tasks that require decision-making based on interaction with the environment, deep reinforcement learning methods using deep neural networks are considered a promising method. In reinforcement learning, an agent learns a policy so that it can perform actions that can obtain optimal rewards in a specific environment.

In the case of existing online reinforcement learning, policies are learned through real-time interaction with the environment. If this requires physical devices (vehicles, drones, robots, etc.), online reinforcement learning can result in significant losses from an economic and social perspective.

Accordingly, an offline reinforcement learning method that performs learning based on pre-collected data without considering online interaction can be applied. Offline reinforcement learning is being applied to various fields by solving problems from a practical perspective that were encountered in online reinforcement learning.

On the other hand, offline reinforcement learning suffers from the distributional shift problem experienced in existing supervised learning. This occurs due to a mismatch between the learning dataset and the test dataset, that is, the learning dataset does not cover all the data.

Specifically, the nature of reinforcement learning, which requires the estimation of information not included in the learning dataset, may lead to incorrect value evaluation of actions.

### RELATED ART REFERENCE

Korean Patent Application Publication No. 10-2020-0062887

### DISCLOSURE

### Technical Problem

In order to solve the problems of the prior art described above, the present invention considers an offline reinforcement learning method so that a specific agent can be learned in an offline environment rather than an online environment, and unlike the existing offline reinforcement learning, an n-step return-based implicit regularization offline reinforcement learning method and apparatus that reflects implicit regularization that does not provide estimation opportunities for samples not included in the dataset are proposed.

### Technical Solution

In order to achieve the above-described object, according to one embodiment of the present invention, an offline reinforcement learning apparatus for n-step return-based implicit regularization comprises a processor; and a memory connected to the processor, wherein the memory comprises program instructions, in response to being executed by the processor, perform operations comprising sampling, among datasets collected in a preset domain, some datasets including state, action, state at the next time point, reward, and return in n-step, calculating an objective function of a state value model that evaluates a value of a specific state using the sampled data set to update a parameter of the state value model, setting a TD (temporal difference) target based on the state value model, calculating an objective function of a state-action value model that evaluates a value of a specific state and action pair based on the set TD target and updating the parameter of the state-action value model, calculating, after updating the state-action value model, an objective function of a policy model for determining an action according to a given state and updating the parameter of the policy model.

The operations may further comprise excluding information about an action and action distribution predicted using the policy being learned from learning of network for learning the policy model.

The state value model may be learned to reduce the difference between the value of a specific state and action pair and the state value, and the value of the specific state and action pair may be replaced by an n-step return considered by discounting a reward during n-step.

A function related to a direction of reducing the difference between the value of the specific state and action pair and the state value may be replaced by an asymmetric loss function.

The operations may further comprise updating, after updating the parameter of the state value model and the parameter of the state-action value model, a parameter for a target value model, and learning, after updating a parameter for the target value model, the policy model.

The policy model may be used to calculate a probability for a state and action pair included in the sampled dataset without making predictions about an action not included in the sampled dataset during the learning process.

The operations may further comprise processing the collected dataset according to a decision-making model determined in each domain.

The operations may further comprise calculating the relative information of each agent and processing state information into observation information, matching observation information in a current step, action information, and observation information in the next step, and calculating a reward using the observation information in the current step, the action information, and the observation information in the next step.

According to another embodiment of the present invention, an offline reinforcement learning method for n-step return-based implicit regularization comprises sampling, among datasets collected in a preset domain, some datasets including state, action, state at the next time point, reward, and return in n-step; calculating an objective function of a state value model that evaluates a value of a specific state using the sampled data set to update a parameter of the state value model; setting a TD (temporal difference) target based on the state value model, and calculating an objective function of a state-action value model that evaluates a value of a specific state and action pair based on the set TD target and updating the parameter of the state-action value model; and calculating, after updating the state-action value model, an objective function of a policy model for determining an action according to a given state and updating the parameter of the policy model.

According to another embodiment of the present invention, a computer program stored on a computer-readable recording medium that performs the above method is provided.

### Advantageous Effects

According to the present invention, there is an advantage in that the problem can be solved more robustly by configuring three elements including a state value model (V value function) that estimates the value of state/observation information, a state-action value model (Q value function) that estimates the value of state and action pairs, and a policy that makes decisions based on given state/observation information and considering the n-step return method, which can guarantee a smaller estimation error than when using a single sample to estimate the V value function.

### DESCRIPTION OF DRAWINGS

These and/or other aspects will become apparent and more readily appreciated from the following description of the embodiments, taken in conjunction with the accompanying drawings in which:

FIG. 1 is a diagram showing the configuration of an offline reinforcement learning apparatus according to an embodiment of the present invention;

FIG. 2 is a diagram showing a data processing process according to the embodiment;

FIG. 3 is a diagram illustrating an offline reinforcement learning process for implicit regularization according to this embodiment;

FIG. 4 is a diagram showing an algorithm of an offline reinforcement learning process for n-step return-based implicit regularization according to the embodiment; and

FIG. 5 is a diagram showing the performance of the algorithm according to the embodiment and the existing algorithm.

### DETAILED DESCRIPTION OF EMBODIMENTS

Since the present invention can make various changes and have various embodiments, specific embodiments will be illustrated in the drawings and described in the detailed description. However, this is not intended to limit the present invention to specific embodiments, and should be understood to include all changes, equivalents, and substitutes included in the spirit and technical scope of the present invention.

The terms used herein are only used to describe specific embodiments and are not intended to limit the invention. Singular expressions include plural expressions unless the context clearly dictates otherwise. In this specification, terms such as “comprise” or “have” are intended to designate the presence of features, numbers, steps, operations, components, parts, or combinations thereof described in the specification, but it should be understood that this does not exclude in advance the presence or addition of one or more other features, numbers, steps, operations, components, parts, or combinations thereof.

In addition, the components of the embodiments described with reference to each drawing are not limited to the corresponding embodiments, and may be implemented to be included in other embodiments within the scope of maintaining the technical spirit of the present invention, and even if separate description is omitted, a plurality of embodiments may be re-implemented as a single integrated embodiment.

In addition, when describing with reference to the accompanying drawings, identical or related reference numerals will be given to identical or related elements regardless of the reference numerals, and overlapping descriptions thereof will be omitted. In describing the present invention, if it is determined that a detailed description of related known technologies may unnecessarily obscure the gist of the present invention, the detailed description will be omitted.

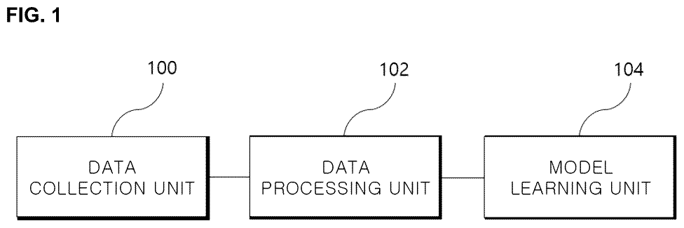

FIG. 1 is a diagram showing the configuration of an offline reinforcement learning apparatus according to an embodiment of the present invention.

As shown in FIG. 1, the apparatus according to this embodiment may comprise a data collection unit 100, a data processing unit 102, and a model learning unit 104.

The data collection unit 100 collects datasets from the domain to be solved.

The collected dataset is for learning an offline reinforcement learning model and can collect the current state in a given environment and actions of agents determined according to the given state.

For example, in the case of autonomous driving, the data collection unit collects the absolute position and speed of vehicles on a specific road as state information using peripheral devices or drones, and collects action information on acceleration and steering angle adjustments considered at each time step.

In addition, when performing network recovery based on devices such as drones, the data collection unit collects the absolute position, speed, direction of movement, and network recovery of each device as state information, and collects acceleration and direction adjustments considered at each time step as action information.

If a dataset exists in advance, the data collection process may be omitted.

The data processing unit 102 processes the collected dataset and performs dataset processing according to the decision-making model (Markov decision process model) determined in each domain.

In the case of an image-based dataset, the data processing unit 102 may perform adjustments such as pixel values, and in the case of a value-based dataset, may process raw data to match the state and observation dimension.

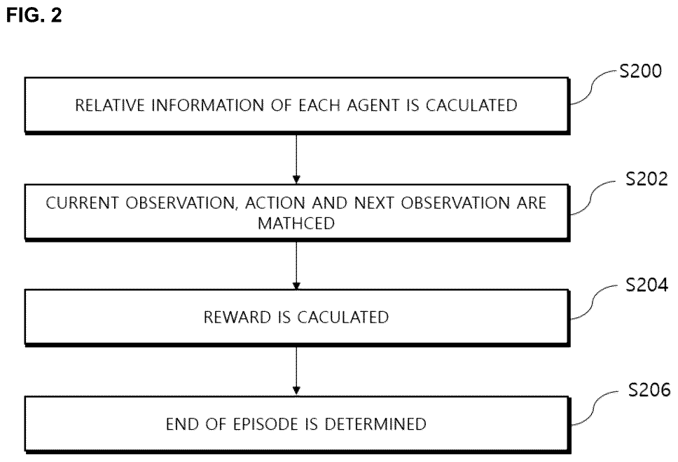

FIG. 2 is a diagram showing a data processing process according to the present embodiment.

Referring to FIG. 2, in order to process state information into observation information, the relative information of each agent is calculated (step 200).

Afterward, the current observation, the action, and the next observation are matched (step 202).

When matching is completed in step 202, the reward is calculated according to the observation information in the current step, the action information, and the observation information in the next step (step 204).

Finally, the data processing process is completed by determining whether the data point is the end of the episode (step 206).

In this embodiment, return is used in a single episode along with reward information to ensure a small estimation error.

Here, the return refers to the result of considering the reward for n-steps by discounting it, and depending on the user's settings, the discount may not be considered when calculating the return.

In steps are determined to consider for n-step return calculation, and return is calculated according to the n-step and reward information.

The model learning unit 104 learns a plurality of models, and at this time, a target value model (target network) may be additionally used to ensure the learning stability of each model.

The model learning unit 104 can learn a state value model (V value function), a state-action value model (Q value function) policy model, and a target value model.

The state value model is a network that outputs the value that can be obtained in a given state space. It takes state information or observation information as input and outputs a value inference value (V_{ψ}(s) of the specific state or observation information.

Hereinafter, it will be explained that the state information includes observation information.

According to this embodiment, the state value model is learned based on the similarity between the value inferred by the state value model for a given state and the n-step return.

The state-action value model outputs a value inference value Q_{θ}(s, a) using a pair of state information-action information or a pair of observation information-action information as input.

The state-action value model uses the state value model in the learning process to bypass the problem of approximating the value of the action at the next time point required by the existing Bellman error.

The decision-making model (policy) can be learned in various ways.

The decision-making model outputs actions π_{ϕ}(a|s) using state information or observation information as input according to a preset policy.

It is learned to infer the optimal action in a given state using the learned state value model and state-action value model. As a specific example, an objective function based on advantage (Q-V) can be used.

Below, the offline reinforcement learning process according to the present embodiment will be described in detail with reference to equations.

Reinforcement learning is formalized as a Markov decision process (MDP), and defined as a tuple M= [symbol] S, [symbol] , [symbol] , r, p₀, Y [symbol] containing an action a in state s.

Here, S is the state set, A is the action set, [symbol] (sₜ₊₁|sₜ, aₜ) the state transition probability, rₜ R(sₜ, aₜ) the reward, p₀ is the initial state distribution, and λ∈[0, 1) is the discount factor.

The purpose of reinforcement learning is to find the optimal policy π*(aₜ, sₜ) that maximizes reward as follows.

$${{G}_{t} \vert}_{s , a} = R ( {s}_{t} = s , {a}_{t} = a ) + {\sum }_{k = 1}^{∞} {γ}^{k} R ( {s}_{t + k} , {a}_{t + k} ) \qquad [ Equation 1 ]$$

Offline reinforcement learning builds a policy by sampling (sₜ, aₜ, sₜ₊₁,rₜ) from a previously collected dataset of the action policy πβ.

The offline reinforcement learning approach minimizes the Bellman error estimate as follows.

$$ℒ ( θ ) = {𝔼}_{( {s}_{t} , {a}_{t} , {s}_{t + 1} , {r}_{t} ) \sim 𝒟} [ {( ( {r}_{t} + γ {Q}_{{θ}^{′}} ( {s}_{t + 1} , π ( {a}_{t + 1} \vert {s}_{t + 1} ) ) ) - {Q}_{θ} ( {s}_{t} , {a}_{t} ) )}^{2} ] \qquad [ Equation 2 ]$$

Here θ and θ′ are the parameters of the state-action value model and the target value model (target network), respectively.

In the above equation, Q_{θ′}(sₜ₊₁, aₜ₊₁) can be replaced using the value inference value V(sₜ₊₁) of the state value model, and the objective function of the state value model is as follows.

$$ℒ ( ψ ) = {𝔼}_{( {s}_{t} , {a}_{t} ) \sim 𝒟} [ {L}_{2}^{τ} ( {Q}_{{θ}^{′}} ( {s}_{t} , {a}_{t} ) - {V}_{ψ} ( {s}_{t} ) ) ] \qquad [ Equation 3 ]$$

Here, L₂^{T}(x)=|T− [symbol] (x<0)|x² refers to the expected quantile (example) regression approach called asymmetric L2 loss, T ∈(0, 1] refers to the expected ratio of the random variable, and [symbol] (·) refers to the indicator function.

The objective function of the state value model consists of the inferred values of the Q value function and the V value function. This can worsen estimation errors when learning the Q value function or policy.

In this embodiment, Q-learning based on n-step return (return) is proposed, and Q_{θ′}(sₜ, aₜ) is replaced with n-step return. The objective function of the state value model can be defined as follows.

$$ℒ ( ψ ) = \qquad [ Equation 4 ]$$

$${𝔼}_{( {s}_{t} , {a}_{t} , {s}_{t + n} , \{ {r}_{t} , {r}_{t + 1} , … , {r}_{t + n - 1} \} ) \sim 𝒟} [ {L}_{2}^{τ} ( {\sum }_{k = 0}^{n - 1} {γ}^{k} {r}_{t + k} + {γ}^{n} {V}_{{ψ}^{′}} ( {s}_{t + n} ) - {V}_{ψ} ( {s}_{t} ) ) ]$$

Here, ψ′ refers to the parameters of the target value model, and the target value model is explained again below. If n is equal to the maximum length of each episode, it operates like Monte Carlo, and if n=1, it is a time difference approach. Here, the objective function of the Monte Carlo version can be simplified as follows.

$$ℒ ( ψ ) = {𝔼}_{( {s}_{t} , {G}_{t} ) \sim 𝒟} [ {L}_{2}^{τ} ( {G}_{t} - {V}_{ψ} ( {s}_{t} ) ) ] \qquad [ Equation 5 ]$$

The objective function can guarantee a reduction in Bellman error λⁿ compared to the optimal value and estimated value.

The main goal of this work is to ensure error reduction compared to the objective function of in-sample learning Q_{θ′}(s, a)−V_{ψ}(s)

Here, L₂^{T}(Gₜ−V_{ψ}(sₜ)) is defined as a function related to the direction of reducing the difference between the value of a specific state and action pair and the state value, and the function can be replaced by an asymmetric loss function. In the process of estimating state-action value, the mean square loss (MSE) function is followed between the current Q inference value and the Bellman target based on the maximized state value inference value V(s′).

$$ℒ ( θ ) = {𝔼}_{( {s}_{t} , {a}_{t} , {s}_{t + 1} ) \sim 𝒟} [ {( r ( {s}_{t} , {a}_{t} , {s}_{t + 1} ) + γ {V}_{{ψ}^{′}} ( {s}_{t + 1} ) - {Q}_{θ} ( {s}_{t} , {a}_{t} ) )}^{2} ] \qquad [ Equation 6 ]$$

As described above, after the parameters of the state value model and state-action value model are updated, the policy model learns a policy that determines the action according to the given state through the objective function below.

$$ℒ ( ϕ ) = {𝔼}_{( {s}_{t} , {a}_{t} ) \sim 𝒟} [ exp ( \frac{max ( {Q}_{{θ}^{′}} ( {s}_{t} , {a}_{t} ) - {V}_{{θ}^{′}} ( {s}_{t} ) , 0 )}{η} ) log {π}_{ϕ} ( {a}_{t} \vert {s}_{t} ) ] \qquad [ Equation 7 ]$$

According to this embodiment, information about the action predicted using the policy being learned (the action queried by the policy) and the action distribution is not used for network learning.

Here, the action queried by the policy refers to the output value of the policy network that receives observation information.

According to this embodiment, the policy model does not make predictions for actions not included in the sampled dataset during the learning process, but is used to calculate the probability (logπ_{ϕ}(aₜ|sₜ)) for state and action pairs included in the sampled dataset.

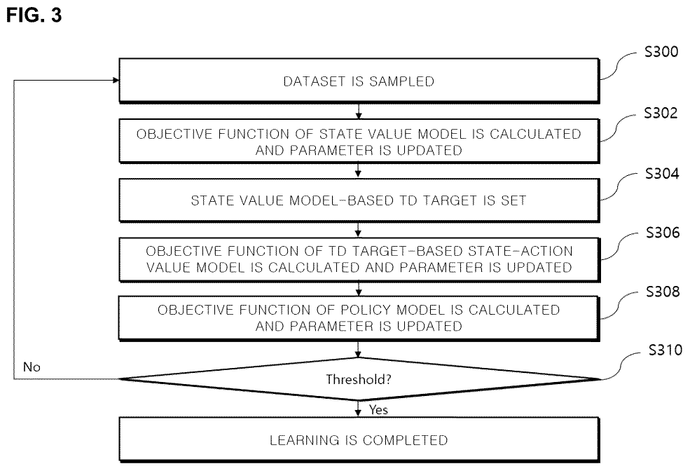

FIG. 3 is a diagram illustrating an offline reinforcement learning process for implicit regularization according to this embodiment.

Referring to FIG. 3, sampling is performed from the dataset (step 300).

Step 300 is a process of sampling some data sets including states, actions, next states, rewards, and accumulated rewards matched to each other from the collected data sets.

Next, the objective function of the state value model is calculated and the state value model is updated (step 302).

As shown in Equation 5, the state value model is learned to reduce the error (difference) between the value of the state-action pair and the state value, and its parameters are updated.

In learning a state value model, either symmetric or asymmetric functions can be used.

After step 302, a state value model-based target is set (step 304).

Here, the target is defined as a TD (Temporal Difference) target, and is the sum of the state values in which reward and discount are considered, as shown in Equation 6.

As shown in Equation 6, according to this embodiment, the target is set based on the state value model without considering the next action.

Based on the set TD target, the objective function of the state-action value model is calculated and the parameters of the state-action value model are updated (step 306).

After updating the state-action value model, the objective function of the policy model to determine the action according to the given state is calculated, and the parameters of the policy model are updated (step 308).

As shown in Equation 7, policy learning according to this embodiment does not perform action prediction, but only evaluates the value of the sampled action in the dataset.

That is, in policy learning according to this embodiment, information about action and action distribution predicted using the policy being learned is excluded from learning of the policy model.

It is determined whether the threshold is reached (step 310), and if the threshold is reached, learning is completed. Otherwise, the process moves to step 300.

After completing model learning, when actually using the model, only the policy model for which learning has been completed is used without using the value model.

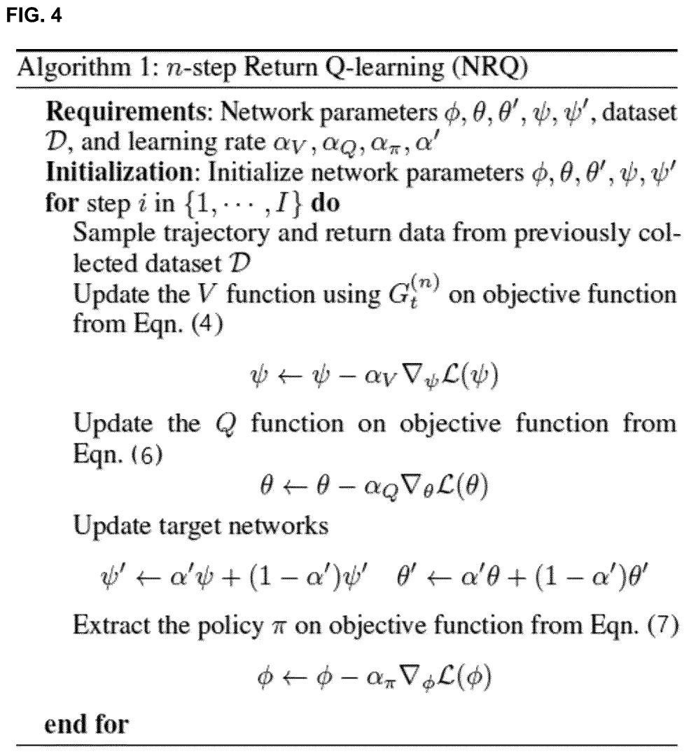

FIG. 4 is a diagram showing an algorithm of an offline reinforcement learning process for n-step return-based implicit regularization according to this embodiment.

Referring to FIG. 4, the process of learning a model is shown in consideration of the target value model to ensure stability, but in some cases, the target value model may not be used.

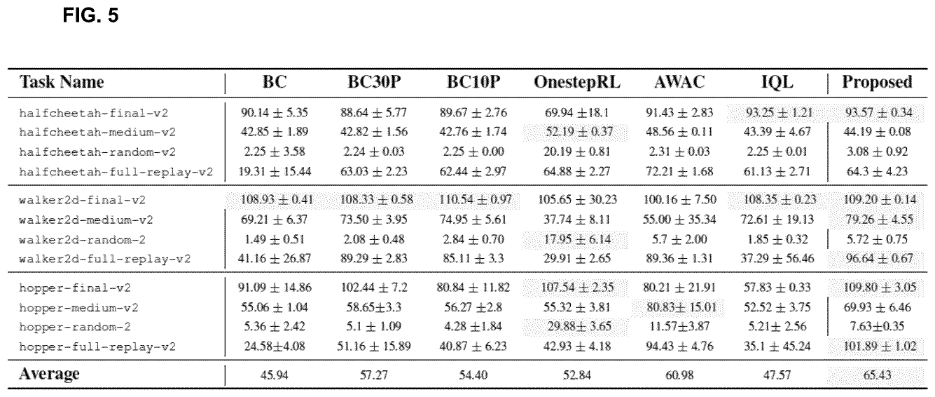

FIG. 5 shows the performance of the algorithm according to this embodiment and the existing algorithm, and it can be seen that the algorithm according to this embodiment shows improved performance in a number of tests.

The embodiments described above may be implemented with hardware components, software components, and/or a combination of hardware components and software components. For example, the devices, methods and components described in the embodiments may be implemented using one or more general-purpose or special-purpose computers, such as, for example, a processor, a controller, a central processing unit (CPU), a graphics processing unit (GPU), an arithmetic logic unit (ALU), digital signal processor, microcomputer, field programmable gate array (FPGA), programmable logic unit (PLU), microprocessor, application specific integrated circuits (ASICS), or any other device capable of executing and responding to instructions.

The offline reinforcement learning method described above can also be implemented in the form of a recording medium containing instructions executable by a computer, such as an application or program module executed by the computer. Computer-readable media can be any available media that can be accessed by a computer and includes both volatile and non-volatile media, removable and non-removable media. Additionally, computer-readable media may include computer storage media. Computer storage media includes both volatile and non-volatile, removable and non-removable media implemented in any method or technology for storage of information such as computer-readable instructions, data structures, program modules, or other data.

The above-described method of configuring an offline reinforcement learning apparatus can be executed by an application installed by default on the terminal (this may include programs included in the platform or operating system, etc. installed by default on the terminal). Alternatively, it may also be executed by an application (i.e., a program) that the user installs directly on the master terminal through an application-providing server such as an application store server, an application, or a web server related to the service. In this sense, the above-described method of configuring an offline reinforcement learning apparatus may be implemented as an application (i.e., a program) installed by default in the terminal or directly installed by the user, and may be recorded on a computer-readable recording medium such as the terminal.

The above-described embodiments of the present invention have been disclosed for illustrative purposes, and those skilled in the art will be able to make various modifications, changes, and additions within the spirit and scope of the present invention, and such modifications, changes, and additions should be regarded as falling within the scope of the patent claims below.

1. An offline reinforcement learning apparatus for n-step return-based implicit regularization comprising:
a processor; and
a memory connected to the processor,
wherein the memory comprises program instructions, in response to being executed by the processor, perform operations comprising,
sampling, among datasets collected in a preset domain, some datasets including state, action, state at the next time point, reward, and return in n-step,
calculating an objective function of a state value model that evaluates a value of a specific state using the sampled data set to update a parameter of the state value model,
setting a TD (temporal difference) target based on the state value model,
calculating an objective function of a state-action value model that evaluates a value of a specific state and action pair based on the set TD target and updating the parameter of the state-action value model,
calculating, after updating the state-action value model, an objective function of a policy model for determining an action according to a given state and updating the parameter of the policy model.

2. The offline reinforcement learning apparatus of claim 1, wherein the operations further comprise,
excluding information about an action and action distribution predicted using the policy being learned from learning of network for learning the policy model.

3. The offline reinforcement learning apparatus of claim 1, wherein the state value model is learned to reduce a difference between the value of a specific state and action pair and the state value,
wherein the value of the specific state and action pair is replaced by an n-step return considered by discounting a reward during n-step.

4. The offline reinforcement learning apparatus of claim 3, wherein a function related to a direction of reducing the difference between the value of the specific state and action pair and the state value is replaced by an asymmetric loss function.

5. The offline reinforcement learning apparatus of claim 1, wherein the operations further comprise,
updating, after updating the parameter of the state value model and the parameter of the state-action value model, a parameter for a target value model,
learning, after updating a parameter for the target value model, the policy model.

6. The offline reinforcement learning apparatus of claim 1, wherein the policy model is used to calculate probability for a state and action pair included in the sampled dataset without predicting an action not included in the sampled dataset during the learning process.

7. The offline reinforcement learning apparatus of claim 1, wherein the operations further comprise,
processing the collected dataset according to a decision-making model determined in each domain.

8. The offline reinforcement learning apparatus of claim 7, wherein the operations further comprise,
calculating relative information of each agent and processing state information into observation information,
matching observation information in a current step, action information, and observation information in a next step,
calculating a reward using the observation information in the current step, the action information, and the observation information in the next step.

9. An offline reinforcement learning method for n-step return-based implicit regularization comprising:
sampling, among datasets collected in a preset domain, some datasets including state, action, state at the next time point, reward, and return in n-step;
calculating an objective function of a state value model that evaluates a value of a specific state using the sampled data set to update a parameter of the state value model;
setting a TD (temporal difference) target based on the state value model, and calculating an objective function of a state-action value model that evaluates a value of a specific state and action pair based on the set TD target and updating the parameter of the state-action value model; and
calculating, after updating the state-action value model, an objective function of a policy model for determining an action according to a given state and updating the parameter of the policy model.

10. The offline reinforcement learning method of claim 9, wherein the state value model is learned to reduce a difference between the value of a specific state and action pair and the state value,
wherein the value of the specific state and action pair is replaced by an n-step return considered by discounting a reward during n-step.

11. The offline reinforcement learning method of claim 9 further comprises,
before updating the parameter of the policy model, updating, after updating the parameter of the state value model and the parameter of the state-action value model, a parameter for a target value model.

12. A computer program stored on a computer-readable recording medium that performs the method of claim 9.
